(19) United States
(12) Patent Application Publication
(10) Pub. No.: US 2006/0060093 A1
(43) Pub. Date: Mar. 23, 2006

(54) Method for manufacturing a cover of a file or the like

(76) Inventor: Guido Peleman, Puurs (BE)

Correspondence Address: BACON & THOMAS, PLLC, 625 SLATERS LANE, FOURTH FLOOR, ALEXANDRIA, VA, 22314, US

(21) Appl. No.: 11/218,604

(22) Filed: Sep. 6, 2005

(30) Foreign Application Priority Data
Sep. 17, 2004 (BE) 2004/0455

(51) Int. Cl. B44B 5/00

(52) U.S. Cl. 101/3.1

(57) ABSTRACT

A method for manufacturing a cover of a file or the like on the basis of a leaf made of a relatively stiff material, whereby at least one folding line is provided in the above-mentioned leaf by embossing the material of the leaf, along the folding line to be realized, on one side of the leaf so as to form a bulge, wherein the formed bulge is embossed in the opposite direction along the folding line on the other side of the leaf, to thus make the leaf flat again, or practically flat, along the folding line.

### BACKGROUND OF THE INVENTION

1. Field of the Invention

The present invention concerns a method for manufacturing a cover of a file or the like, more particularly of a file for classifying documents and other papers, of the type of a ring binder, insert file or the like.

2. Discussion of the Related Art

It is known that such a cover can be made of a leaf made of a relatively stiff material, such as cardboard or the like, by folding this leaf along certain folding lines to thus form a cover in order to construct a file or the like.

In order to simplify the folding of the leaf, folding lines are provided beforehand by weakening the leaf along these lines, for example by embossing the cardboard leaf locally over a short distance by means of a die and a counter die.

A disadvantage of this method is that when applying the folding lines on one side of the leaf, a bulge is created which prevents the cardboard leaf from being fed through a printer in order to provide a print. fed through a printer in order to provide a print.

For, such a leaf with a bulge on one side could jam the feed-through mechanism of the printer and could moreover damage the printer head of the printer, as it is always situated close to the material to be printed and could consequently get stuck behind the bulge.

A disadvantage coupled thereto is that any print one wishes to make on the file must be provided beforehand, i.e. before the folding lines are provided in the cardboard, or that special printers must be provided whose feed-through mechanism and printer mechanism are adapted so as to be able to print such leaves.

A consequence thereof is that providing a customized print is practically excluded at end user or at print shop level, since they would have to make investments either in a specially adapted printer, or in a device for applying folding lines after the printing.

Even if one was prepared to invest in a special printer, then it would still be impossible to provide a print that continues over the bulges at the folding lines.

### SUMMARY OF THE INVENTION

The present invention aims to remedy the above-mentioned and other disadvantages by providing a method which makes it possible to form a cover of a file or the like which is provided with folding lines and which can be printed on with a conventional printer.

To this end, the invention concerns a method for manufacturing a cover of a file or the like on the basis of a leaf made of a relatively rigid material, whereby at least one folding line is provided in the above-mentioned leaf through the material of the leaf, along the folding line to be realized, by embossing one side of the leaf to be printed in order to form a bulge, and whereby the formed bulge is embossed along the folding line on the other side of the leaf in the opposite sense to thus make the leaf flat again, or practically flat, along the folding line.

An advantage of this method is that a flat leaf is obtained with one or several folding lines which can be printed on by means of a conventional printer or any other conventional printing device and which, as a consequence, can be provided with a print at the print shop or end user level without any extra investments being required.

Another advantage is that the print can be provided in a continuous manner over the folding lines by means of a conventional printer.

For both manipulations, i.e. embossing the leaf in one direction and pushing the bulge back in the other direction, use is preferably made of a die and a counter die working in conjunction with the latter, as is used at present to form folding lines in the existing files.

Thus, for the method according to the invention, use can be made of the existing devices for manufacturing covers of files.

Depending on the type of material out of which the leaf is made, it may be useful in certain cases to specially flatten the leaf at the folding lines, such that it is certain that the leaf can be printed on by means of a printer without any risk of the printer getting stuck or being damaged.

The leaf is preferably provided with a printable coating on one side or on both sides which is preferably applied after the folding lines have been provided in the leaf, such that the coating cannot be damaged while the folding lines are embossed, and such that, as a consequence, more force can be applied when embossing the folding lines in the leaf.

### BRIEF DESCRIPTION OF THE DRAWINGS

In order to better explain the characteristics of the invention, the following preferred applications of methods according to the invention are described as an example only without being limitative in any way, with reference to the accompanying drawings, in which:

FIG. 1 is a schematic representation in perspective of a first stage of a method according to the invention for producing a cover of a file;

FIG. 2 represents a section according to line II-II in FIG. 1 to a larger scale, but after the first stage of the method has been completed;

FIGS. 3 to 9 are similar views as that of FIG. 2, but during successive stages of the method according to the invention;

FIG. 10 represents a variant of FIG. 4;

FIG. 11 represents a variant of a cover which is made according to a method of the invention;

FIG. 12 represents a file which is formed on the basis of the cover of FIG. 11.

### DESCRIPTION OF THE PREFERRED EMBODIMENTS

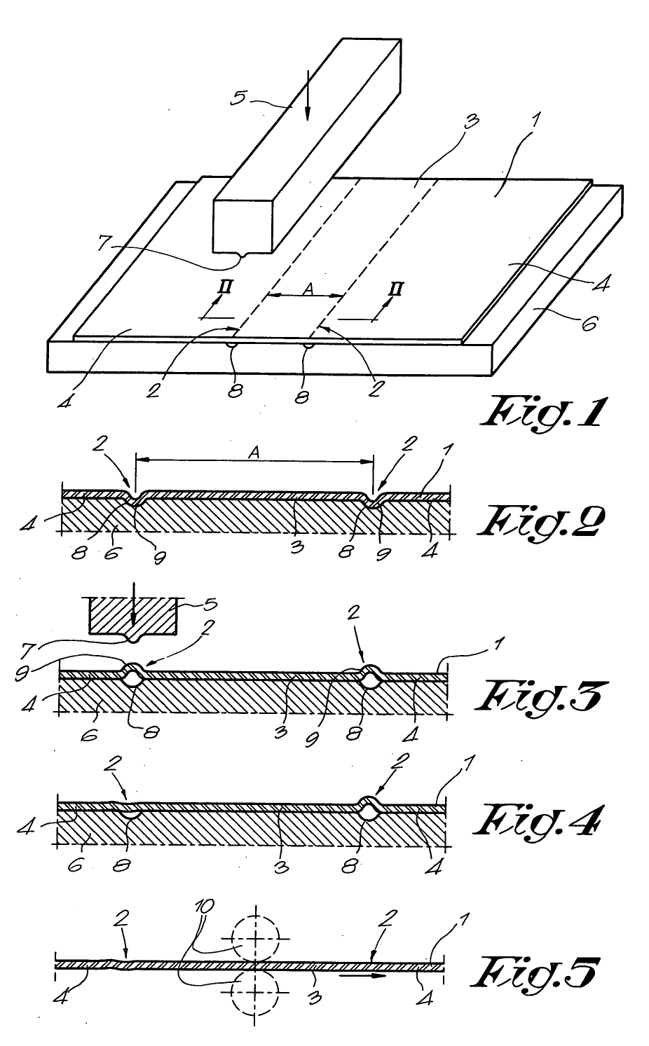

FIG. 1 schematically represents a first stage of a method according to the invention for manufacturing a cover of a file on the basis of a cardboard leaf 1 or the like, whereby this first stage consists in providing folding lines 2 in the leaf, in other words lines along which the material of the leaf is locally weakened so as to be able to easily fold the leaf along these folding lines at a later stage in order to form the cover of the file to be manufactured.

In the given example, two parallel folding lines 2 are provided which define a middle strip 3 with a width A and two side strips 4 of the leaf 1.

The folding lines 2 are provided in the leaf 1 in the known manner by means of a die 5 and a counter die 6 working in conjunction with it, whereby the die 5 is in this case provided with a parallel rib 7 and the counter die 6 is made in the form of a table in which are provided one, or in this case two corresponding parallel grooves 8 at a distance A from each other, opposite to the above-mentioned rib 7 of the die 5.

At this first stage of the method, the leaf 1 is placed on the counter die 6 and positioned on it in an appropriate manner, for example by pushing the leaf with one or two edges up against a stop which is not represented in the figures.

Next, the die 5 is pushed against the counter die 6, for example by means of a hydraulic screw jack which is not represented in the figures, in a direction perpendicular to the plane of the leaf 1, as a result of which the material of the leaf 1 is embossed at a folding line 2, by the rib 7 of the die 5, in a groove 8 of the counter die 6, such that at the folding line 2 concerned is created a bulge 9, as is represented in FIG. 2.

In this manner are successively realized two parallel folding lines 2 at a distance A from each other.

At a subsequent stage of the method according to the invention, the leaf 1 is turned and, as represented in FIG. 3, placed on the counter die 6, such that the formed bulges 9 extend above the grooves 8 of the counter die 6.

Next, the die 5 is pushed against the counter die 6 again, and the bulges 9 are successively pushed back in this manner, as a result of which the leaf 1, as is represented in FIG. 4, after the withdrawal of the die 5, assumes a flat or practically flat shape again, also at the folding lines 2 and on both sides of the leaf 1, whereby the material of the leaf 1 is weakened so much at the folding lines 2, however, that the leaf 1 can be easily folded manually along these lines.

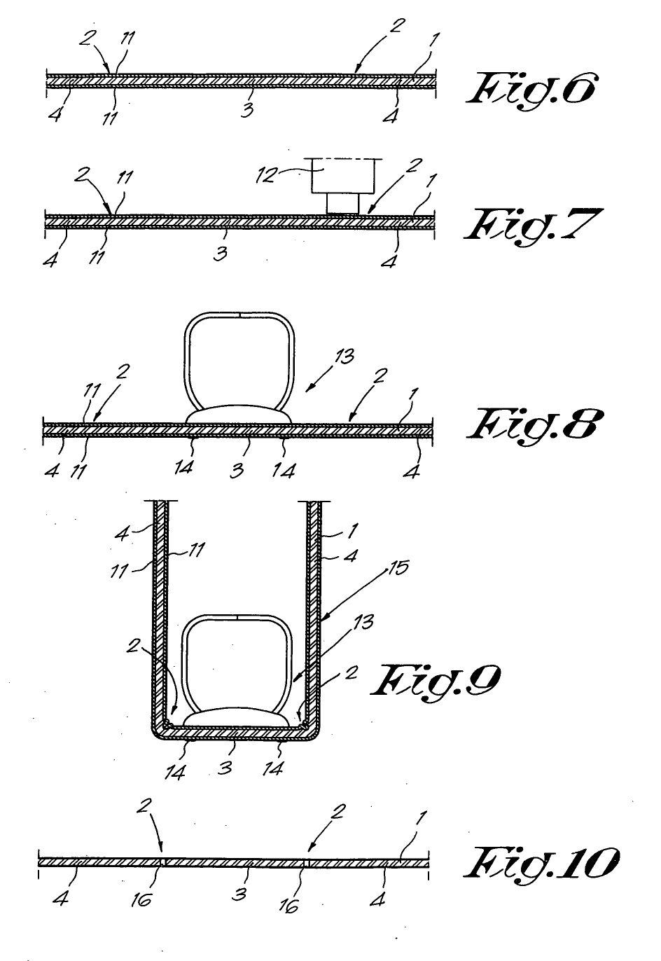

Depending on the type of material out of which the leaf 1 is made, a final processing may be necessary in some cases, in order to make sure that the leaf 1 is entirely flat, for example by flattening the leaf 1 at a next stage, as is represented in FIG. 5, between two rollers 10 or the like.

As is represented in FIG. 6, the leaf 1 may be optionally provided on one side or on both sides with a printable coating 11, whereby this coating 11 is then preferably provided after the above-mentioned stages, although it is not excluded for the coating 11 to be provided beforehand on the leaf 1, in other words before realizing the folding lines 2 in the leaf 1.

Thanks to the fact that the treated leaf 1 has a flat shape, at a subsequent stage, as is schematically represented in FIG. 7, the leaf 1 can be printed on by means of a conventional printer with a conventional printer head 12, or it can be treated with a plasticizing device, and moreover the print can be provided in a continuous manner over the folding lines 2.

In this manner is obtained a printed cover of a file or the like.

At a subsequent stage, additional parts of the file to be manufactured may be provided on the above-mentioned cover if required.

By way of example, FIG. 8 shows how an additional part in the shape of a closing mechanism 13 of a ring binder is fixed on the middle strip 3 of the cover by means of rivets 14 or the like.

Once the additional parts have been mounted, the cover can be transformed into a file 15 by folding the two side strips 4 towards each other, as is represented in FIG. 8, along the folding lines 2, whereby these side strips 4 form the front leaf and the back leaf of the file 15 respectively, and the middle strip 3 forms the back.

Depending on the rigidity and the thickness of the leaf 1, it may be advisable in some cases to provide additional perforations 16, as represented in FIG. 10, at the folding lines 2, in order to further weaken the leaf 1 locally and to thus further facilitate the folding of the leaf 1 along these folding lines 2.

It goes without saying that also other forms and types of covers for a file can be realized with the method according to the invention.

For example, FIG. 11 represents a cover whereby a number of parallel folding lines 2 are provided in the leaf 1 in this case, which define a number of strips 17 to 21, whereby these folding lines 2 are realized according to the above-described method according to the invention so as to obtain a cover with an entirely flat structure which can be provided with a print by means of a conventional printer or plasticizing device.

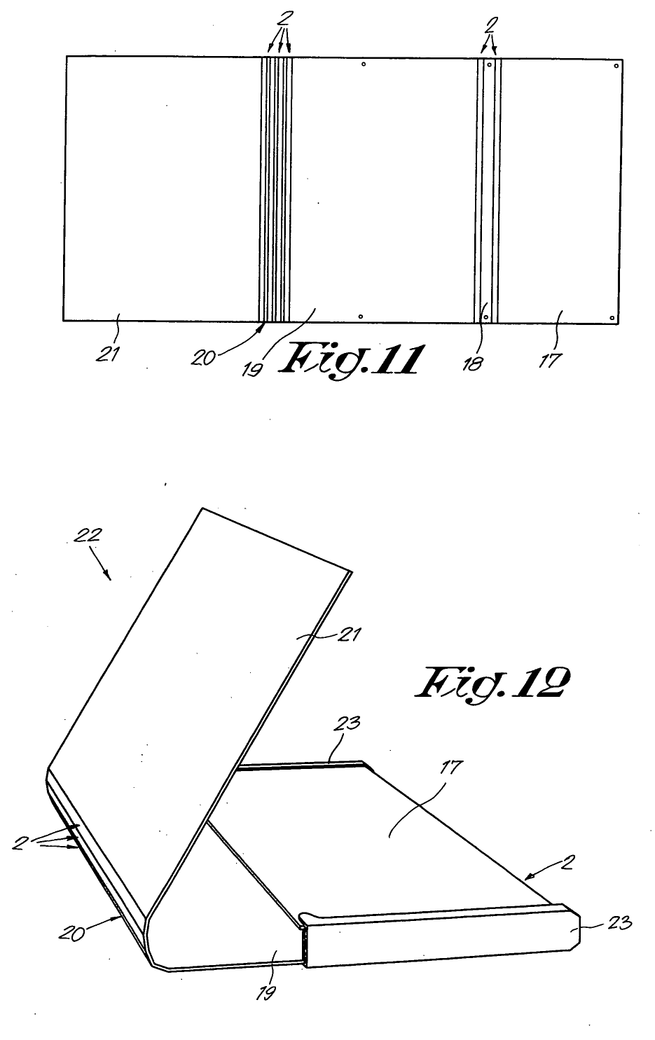

Such a cover, as in FIG. 11, makes it possible to form an insert file 22 or what is called a portfolio file in the known manner, by folding the cover, as is represented in FIG. 12, whereby the strip 18 forms the back of the insert file 22 and the strips 17 and 19 form two walls respectively of the insert file 22 which are fixed to each other along their free edges by means of sealing parts 23 so as to form a space 24 which can be partly sealed by means of a flap formed by the strip 21.

It is clear that the method according to the invention is not restricted to the formation of parallel, straight folding lines, but that also straight and bent folding lines in different shapes and according to different directions can be combined.

It is also clear that, although the figures always represent a rectangular leaf 1, it is not excluded to form a cover on the basis of a leaf 1 having a more complex shape, whereby for example certain parts have been cut out or punched out of the leaf.

Although, in order to form a cover of a file, in practice, a cardboard leaf 1 is usually taken as a basis, it is not excluded to apply the method according to the invention on leaves 1 made of another material.

Although, in the above-described method, use is made of a die 5 and a counter die 6 for embossing the folding lines 2 and for pushing them back, it is not excluded to use other means to that end.

In order to avoid having to turn the leaf 1 during the method, a die can be provided on either side of the leaf 1 according to an alternative method, such that a single die can be used to emboss the folding lines in one direction, while the other die is then used to emboss the folding lines in the opposite sense.

The present invention is by no means limited to the method according to the invention given as an example and represented in the accompanying drawings; on the contrary, it can be used according to all sorts of variants while still remaining within the scope of the invention.

1. A method for manufacturing a cover of a file in the form of a leaf made of a relatively stiff material, comprising the steps: providing at least one folding line a leaf of relatively stiff material by embossing the material of the leaf along at least one selected folding line along one direction, on one side of the leaf so as to form a bulge; and embossing, the formed bulge in the opposite direction along the folding line on the other side of the leaf, to thus make the leaf substantially flat again, along the at least one folding line.

2. The method according to claim 1, wherein in order to emboss the leaf at the at least one folding line, use is made of a die and a counter die working in conjunction with it.

3. The method according to claim 2, wherein in order to emboss the leaf in the one direction as well as in the opposite direction use is made of a die and counter die which are identical or similar.

4. The method according to claim 1, wherein after the at least one folding line has been formed, the leaf is flattened.

5. The method according to claim 1, including providing perforations along the at least one folding line.

6. The method according to claim 1, including providing the leaf with a printable coating on one or both sides.

7. The method according to claim 6, including providing the coating after the at least one folding line has been formed.

8. The method according to claim 1, wherein the leaf, irrespective of whether it has been provided beforehand with a coating or not, is imprinted a printer.

9. The method according to claim 1, wherein the leaf is provided with at least two folding lines.

10. The method according to claim 1, including folding the leaf along the formed at least one folding line to form the cover of a file.

11. The method according to claim 10, wherein the leaf forms the cover of a ring binder.

12. The method according to claim 10, wherein the leaf forms the cover of an insert file.

13. The method according to claim 1, wherein the material is cardboard.
